(19) United States
(12) Patent Application Publication
(10) Pub. No.: US 2024/0362379 A1
(43) Pub. Date: Oct. 31, 2024

(54) CRITICAL PLANE BASED MULTI-AXIAL FATIGUE METHOD IN FREQUENCY DOMAIN

(71) Applicant: FCA US LLC, Auburn Hills, MI (US)

(72) Inventors: Eniyavan Subramanian, LaSalle (CA); Robert Keinti, Madison Heights, MI (US); Yung-Li Lee, Troy, MI (US); Sandip Datta, Troy, MI (US)

(21) Appl. No.: 18/309,292

(22) Filed: Apr. 28, 2023

(51) Int. Cl. G06F 30/23

(52) U.S. Cl. CPC G06F 30/23; G06F 2111/10

(57) ABSTRACT

A method for predicting fatigue life of a structure includes providing a finite element (FE) model of the structure; calculating a modal stress and a frequency response function (FRF) of the FE model; calculating a stress power spectral density (PSD) matrix; calculating a damage transformation matrix [A]; calculating a covariance matrix from the stress PSD matrix; determining angles θ, φ, and ψ in a plane with maximum equivalent variance based on the calculated covariance matrix; and calculating a variance—damage parameter with the angles θ, φ, and ψ incremented in a predetermined amount of degrees to thereby identify critical planes where a fatigue crack will occur in the structure.

### FIELD

The present application relates generally to fatigue life prediction and, more particularly, to a critical plane based multi-axial method to predict fatigue life in vehicle components/structures in frequency domain.

### BACKGROUND

Mechanical fatigue is an important factor when designing vehicle components/structures which are subject to random and dynamic excitation loads like those experienced while driving on a road. Accordingly, performing numerical analyses to predict fatigue life improves component life and reduces development time and cost. However, conventional testing may only analyze single-axial fatigue, which is not representative of real-life fatigue for components that experience random dynamic loads. Recent developments in multi-axial fatigue are based on signed von-Mises criteria and a critical plane method. However, signed von-Mises criteria do not account for non-proportional effects in multi-axial loading, and the current critical plane method only accounts for one component of shear stress in the critical plane. As such, it may be difficult to adequately capture failure mechanisms. Accordingly, while such methods do work for their intended purpose, there is a desire for improvement in the relevant art.

### SUMMARY

In accordance with one example aspect of the invention, a computer-implemented method for predicting fatigue life of a structure is provided. In one example, the method includes providing a finite element (FE) model of the structure; calculating, with a computing device having one or more processors, a modal stress and a frequency response function (FRF) of the FE model; calculating, with the computing device, a stress power spectral density (PSD) matrix; calculating, with the computing device, a damage transformation matrix [A]; calculating, with the computing device, a covariance matrix from the stress PSD matrix; determining, with the computing device, angles θ, φ, and ψ in a plane with maximum equivalent variance based on the calculated covariance matrix, where θ is an angle the plane makes with the x-axis, φ is an angle the plane makes with the z-axis, and ψ is an angle of equivalent shear in a shear plane; and calculating, with the computing device, a variance—damage parameter with the angles θ, φ, and ψ incremented in a predetermined amount of degrees to thereby identify critical planes where a fatigue crack will occur in the structure.

In addition to the foregoing, the described method may include one or more of the following features: calculating, with the computing device, a PSD—damage parameter based on the identified critical planes, the transformation matrix [A], and the PSD matrix to thereby provide a stress PSD as a function of frequency; calculating, with the computing device, a damage based on the PSD—damage parameter, to thereby estimate the fatigue life of the structure; wherein the damage transformation matrix [A] is calculated based on material constants of the structure and direct and shear transformation vectors; and wherein the predetermined increment of angles θ, φ, and ψ is 5°.

In accordance with one example aspect of the invention, a computer-implemented method for predicting fatigue life of a structure is provided. In one example, the method includes providing a finite element (FE) model of the structure; calculating, with a computing device having one or more processors, a modal stress and a frequency response function (FRF) of the FE model; determining a unit dynamic stress response based on the calculated modal stress and FRF; calculating, with the computing device, a stress power spectral density (PSD) matrix based on the determined unit dynamic stress response; and calculating, with the computing device, a damage transformation matrix [A] based on material constants of the structure and direct and shear transformation vectors.

The method further includes calculating, with the computing device, a covariance matrix [V] from the stress PSD matrix using zeroth moment; determining, with the computing device, angles θ, φ, and ψ in a plane with maximum equivalent variance based on the calculated covariance matrix [V], where θ is an angle the plane makes with the x-axis, φ is an angle the plane makes with the z-axis, and ψ is an angle of equivalent shear in a shear plane; calculating, with the computing device, a variance—damage parameter with the angles θ, φ, and ψ incremented in a predetermined amount of degrees to thereby identify critical planes where a fatigue crack will occur in the structure; calculating, with the computing device, a PSD—damage parameter based on the identified critical planes, the transformation matrix [A], and the PSD matrix to thereby provide a stress PSD as a function of frequency; and calculating, with the computing device, a damage based on the PSD—damage parameter, to thereby estimate the fatigue life of the structure.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a flow diagram of an example computer-implemented method for predicting fatigue life in a structure, in accordance with the principles of the present application;

FIG. 2 illustrates critical damage stress in time domain, in accordance with the principles of the present application;

FIG. 3 illustrates an example stress transformation, in accordance with the principles of the present application;

FIG. 4 illustrates example damage stress components in time domain, in accordance with the principles of the present application;

FIG. 5 illustrates an example spectral density matrix of the damage stress, in accordance with the principles of the present application;

FIG. 6 illustrates an example identification of a critical plane on maximum variance, in accordance with the principles of the present application; and

FIGS. 7-8 illustrate an example fatigue calculation using the Dirlik method, in accordance with the principles of the present application.

### DETAILED DESCRIPTION

According to the principles of the present application, systems and methods are described for predicting fatigue life in vehicle components or systems such as body, frame, battery packs, or electric drive motors. The methods described herein utilize a critical plane based multi-axial fatigue analysis in frequency domain. In order to capture the inertial effects of random and dynamic excitations caused by a road profile, fatigue analysis is conducted in frequency domain as opposed to time domain. Because the loads are random, the method defines the random loads using a statistical quantity known as power spectral density (PSD), and efficiently captures the fatigue failure mechanism more closely using a multi-axial PSD based analysis. In this way, the method facilitates predicting fatigue life in the early stages of design to promote robust design with optimum weight.

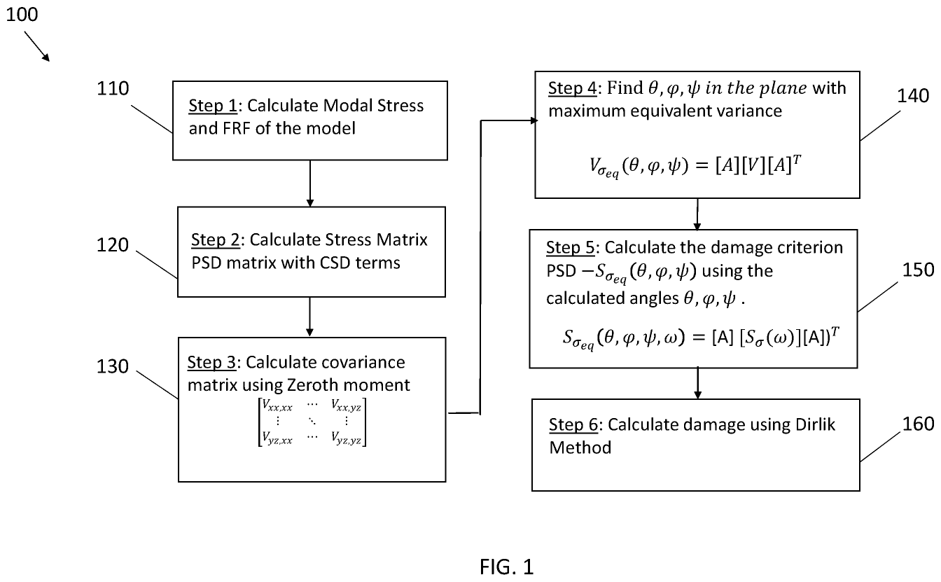

Referring now to FIG. 1, an example computer-implemented method 100 for predicting fatigue life in a structure is disclosed in accordance with the principles of the present disclosure. In the example embodiment, the method 100 generally calculates multi-axial fatigue by exciting the structure simultaneously with multiple excitations. Structure damage is calculated on critical planes, which are identified by searching both normal and shear planes. The method 100 can be performed by any computing device or devices. For ease of description, the method 100 will be described hereinafter as being performed by a single computing device. It should be appreciated, however, that other devices may be utilized to perform some or all of the described method 100.

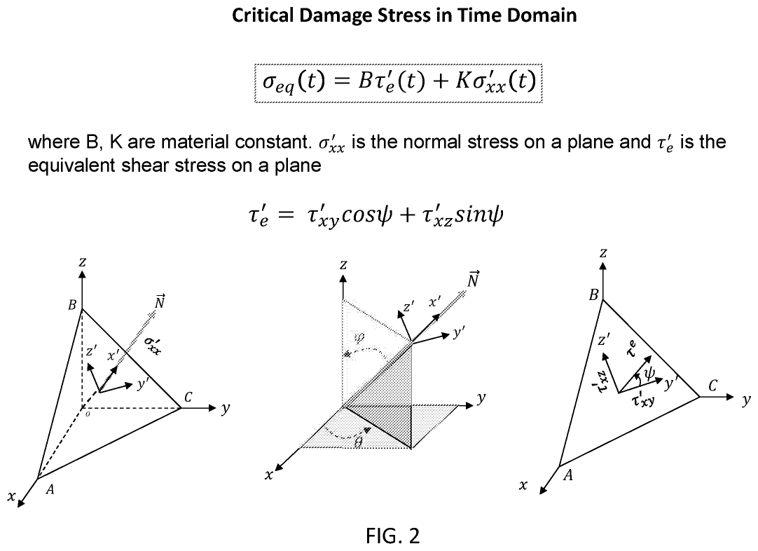

In performing method 100, FIGS. 2-8 provide insight and background for the calculations and determinations made, which are described herein in more detail. FIG. 2 generally illustrates a global coordinate system x, y, and z. A plane ABC is shown with a normal vector N and a local coordinate x′, y′, and z′. The local coordinate x′ is normal to the plane, and the normal vector N makes an angle φ with the z-axis of the global coordinate. The projection of the normal vector N makes an angle θ with the x-axis of the global coordinate. τ_{xy}′ and τ_{xz}′ are the two components of shear stresses in the local coordinate system. τₑ′ is equivalent shear stress in the shear plane which makes an angle ψ with the y′ of the local coordinate system. σₓₓ′ is the normal direct stress on the local coordinate system, and σ_{eq}(t) is the critical damage stress in time domain.

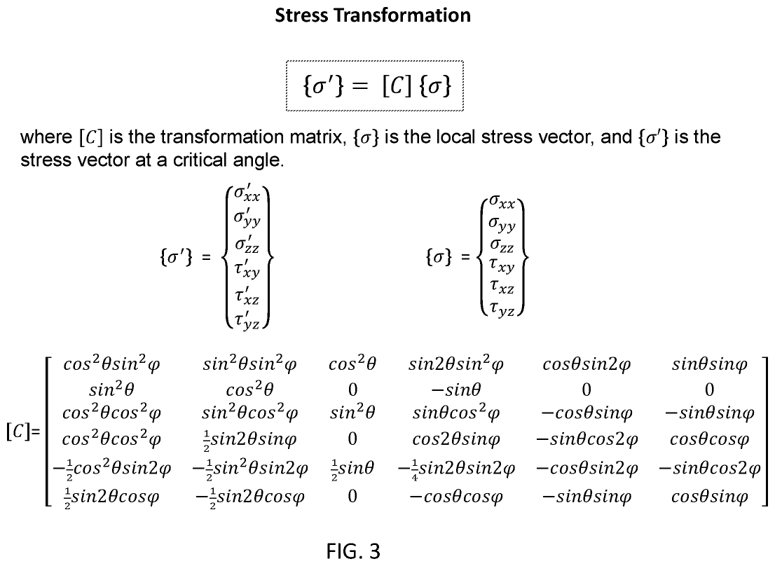

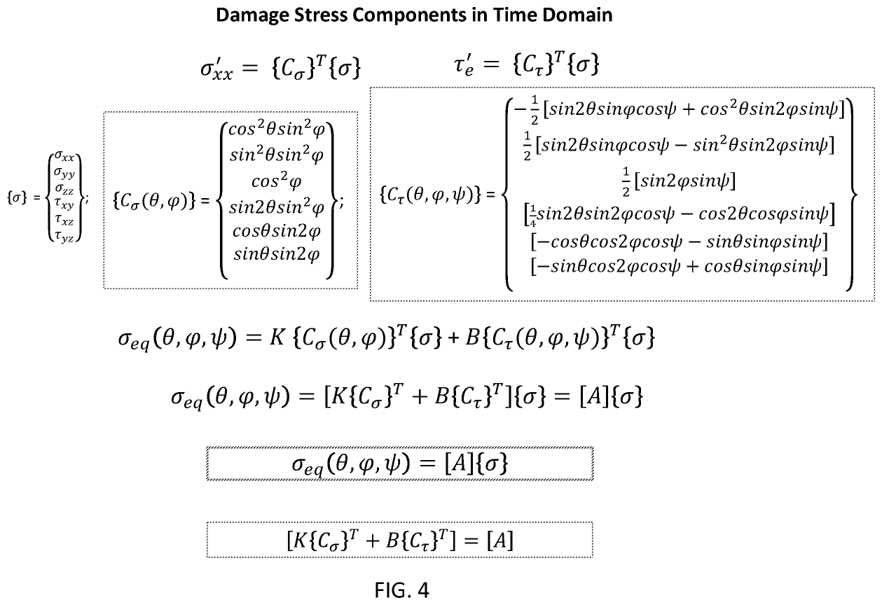

FIG. 3 generally illustrates a transformation relationship between stress σ′ in the local coordinate system to σ in the global coordinate system using a transformation matrix [C]. The transformation matrix [C] depends on angles θ and φ. FIG. 4 generally illustrates reduced equations to extract only the normal direct stress σₓₓ′ and the equivalent shear stress τₑ′ from the equation shown in FIG. 3. Based on these two stress components, damage parameter σ_{eq} in time domain is shown. σ_{eq} can be calculated directly for different angles using the damage transformation matrix [A].

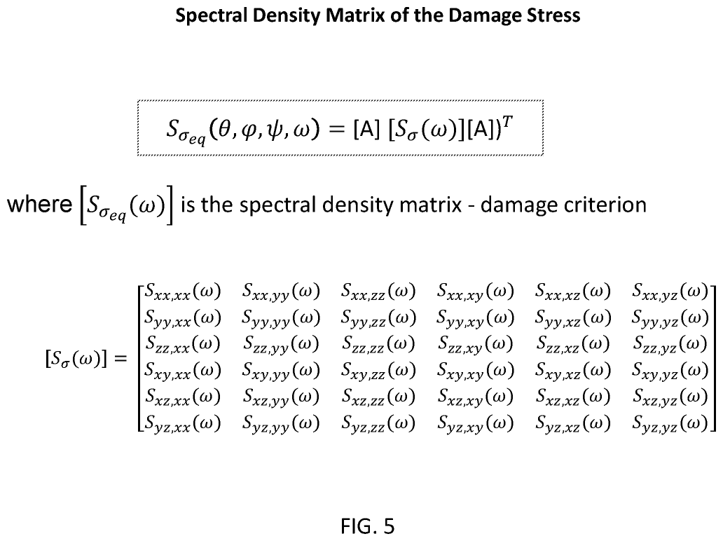

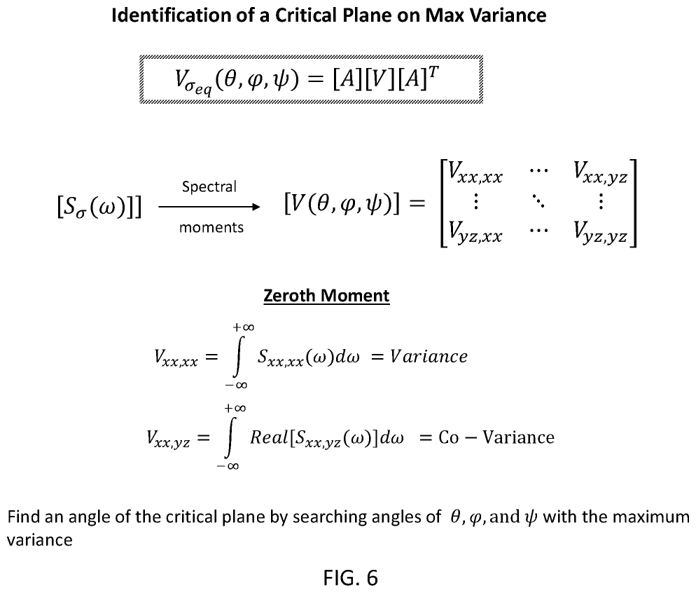

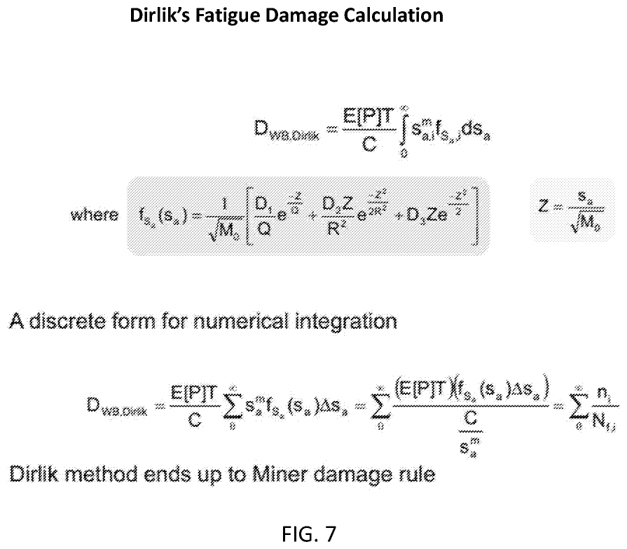

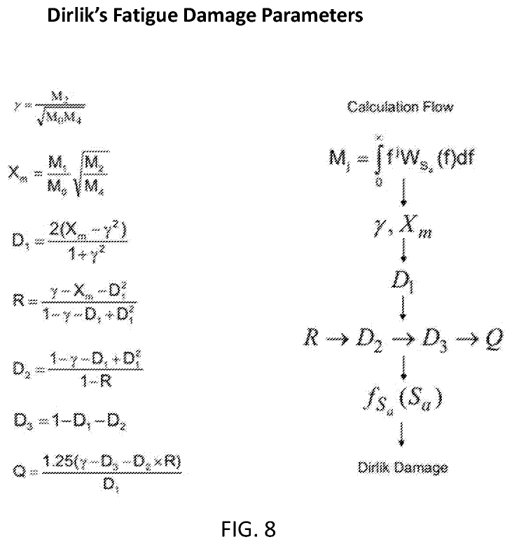

FIG. 5 generally illustrates the damage parameter equation in frequency domain and the PSD stress matrix S_{σ}(ω). FIG. 6 generally illustrates equations to relate a variance—damage parameter V_{σ}_{_{eq}} with the Variance V, as well as a method to calculate a variance matrix V from the PSD stress matrix S_{σ}(ω) using zeroth moments. FIGS. 7-8 generally illustrates an example fatigue damage calculation using the Dirlik method (FIG. 7) and example parameters (FIG. 8) therefor.

In the example embodiment, the method begins at step 110 by providing a model of a structure to be analyzed, represented using finite elements (FE). The FE model is a mathematical representation of a physical system (e.g., a vehicle structure/component), which is separated into a finite number of smaller elements. Each element is defined by one or more nodes, which are assigned spatial coordinates to accurately represent the system geometry. The nodes are each associated with a set of variables that describe the physical properties (e.g., stress) at that point in space.

Each element is typically assigned one or more equations that describe its behavior, and the equations are combined to a create a system of equations that define the behavior of the entire structural system. The FE model often takes into account the geometry of the structure, properties of the structure materials, and boundary conditions to create a representation of the physical behavior of the system. The FE can then be used to analyze system responses to various inputs such as, for example, forces experienced by a vehicle traveling on a roadway.

Continuing with method step 110, the computing device then calculates a modal stress and a frequency response function (FRF) of the FE model. The modal stress analysis is a computational technique used to analyze and understand the dynamic behavior of the structure/system in terms of its natural modes of vibration. When a linear structure is subjected to random dynamic loads represented using PSD ([S_{F}(ω)], Power Spectral Density), a response stress PSD can be calculated using a Modal superposition technique. A PSD describes the distribution of power over a frequency interval for dynamic loads that are caused by a random process. Computer-aided engineering (CAE) based modal superposition is a widely used technique where a structure to be validated is modeled using finite elements. In one example, the modal analysis is initially conducted using the FE model with appropriate boundary conditions. Natural frequencies (ωₙ) and modal stresses (φₓₙ^{σ}) are calculated at each node with the modal analysis.

Next, the FRF analysis is conducted to measure and analyze a dynamic response of the structure/system to a harmonic input signal at varying frequencies. This analysis is useful to analyze vibrational loads on the structure/system. The FRF commonly describes the amplitude and phase of the system's response to the input signal at each frequency. The amplitude of the FRF indicates the system's ability to transmit the input signal at a particular frequency, while the phase indicates a delay between the input and output signals. In some examples, the FRF can be measured experimentally using a shaker or other mechanical excitation device.

In the example embodiment, the FRF analysis is conducted using a unit load applied to the FE structure to obtain a generalized displacement (Qₙ(ω)). A unit dynamic stress ({σ(ω)}) response is then calculated using equation (1) as shown below, based on the natural frequencies (ψₙ) and modal stresses (φₓₙ^{σ}) calculated in the modal analysis for each node.

$$\{ σ ( ω ) \} = \{ \begin{matrix}{φ}_{11}^{σ} \\ {φ}_{21}^{σ} \\ {φ}_{31}^{σ}\end{matrix} \} {Q}_{1} ( ω ) + \{ \begin{matrix}{φ}_{12}^{σ} \\ {φ}_{22}^{σ} \\ {φ}_{32}^{σ}\end{matrix} \} {Q}_{2} ( ω ) + \{ \begin{matrix}{φ}_{13}^{σ} \\ {φ}_{23}^{σ} \\ {φ}_{33}^{σ}\end{matrix} \} {Q}_{3} ( ω ) + … \{ \begin{matrix}{φ}_{1 n}^{σ} \\ {φ}_{2 n}^{σ} \\ {φ}_{3 n}^{σ}\end{matrix} \} {Q}_{n} ( ω ) , \qquad ( 1 )$$

where φₓₙ^{σ} is the modal stress, and Qₙ(ω) is the generalized displacement.

At step 120, the computing device calculates a stress PSD matrix with cross spectral density (CSD) terms. In one example, the stress PSD matrix is a mathematical representation used to analyze the response of the structure to dynamic loading with a matrix describing stress fluctuations of the structure over a range of frequencies. The stress PSD matrix is obtained by applying a dynamic load to the structure and measuring the resulting stresses at different points in the structure. The stresses are then analyzed to obtain the PSD matrix, which describes the power of the stress fluctuations at the various frequencies. Analyzing the stress PSD matrix provides information on how the stress levels in the structure vary with time and frequency, and can identify dominant frequencies that contribute to the stress levels, as well as locations in the structure that are most affected by the dynamic loading.

In this step, the PSD matrix [S_{σ}(ω)], which contains the CSDs, is calculated using the unit dynamic stresses ({σ(ω)}) calculated from step 110 and a load PSD ([S_{F}(ω)]), for example, as applied when exciting the structure to be analyzed. The PSD matrix [S_{σ}(ω)] is calculated with equation (2) below.

$$[ {S}_{σ} ( ω ) ] = {[ \{ σ ( ω ) \} ] [ {S}_{F} ( ω ) ] [ \{ σ ( ω ) \} ]}^{* T} \qquad ( 2 )$$

where {σ(ω)} is unit dynamic stress, [S_{F}(ω)] is the stress PSD in global coordinates, T denotes transpose matrix, and * is the complex conjugate. All terms in the stress PSD matrix [S_{σ}(ω)] are shown in FIG. 5.

In the example embodiment, a damage transformation matrix [A] is then calculated using equation (3) shown below.

$$[ K {\{ {C}_{σ} \}}^{T} + B {\{ {C}_{τ} \}}^{T} ] = [ A ] , \qquad ( 3 )$$

where K and B are material constants of the structure material, and C_{σ} and C_{τ} are the direct and shear transformation vectors shown in FIG. 4 and obtained from, for example, FIGS. 2-3.

At step 130, the computing device calculates a covariance matrix using a zeroth moment. In this step, a covariance matrix [V] is calculated from the stress PSD matrix [S_{σ}(ω)] calculated in step 120 using zeroth spectral moment, for example, as shown in FIG. 6.

A covariance matrix is a mathematical tool used in statistics to describe the linear relationship between multiple variables. It is a square matrix that summarizes the covariances between all pairs of variables. In one example, the covariance matrix is calculated using the zeroth spectral moment. The spectral moment is a mathematical concept used in signal processing and can be calculated from the PSD of a signal. As previously noted, the PSD is a measure of how much of the signal's power is distributed over different frequency bands.

To calculate the covariance matrix using the zeroth spectral moment, the PSD of the data is estimated, for example, using a Fourier transform or similar technique. Once the PSD is obtained, the zeroth spectral moment is calculated by integrating the PSD over all frequencies, which provides a scalar value that represents the total power of the signal. Next, the PSD is normalized by dividing by the zeroth spectral moment, which results in a new function called the normalized PSD. Finally, the covariance matrix is calculated by taking the inverse Fourier transform of the normalized PSD, resulting in a matrix having elements that represent the covariances between each pair of variables.

At step 140, the computing device determines angles θ, φ, and ψ in the plane with maximum equivalent variance. Angles θ, φ, and ψ are shown, for example, in FIG. 2. As the variance—damage parameter V_{σ}_{_{eq}} depends on angles θ, φ, and ψ, a plurality of calculations is made for variance—damage parameter V_{σ}_{_{eq}} at predetermined angle increments for angles θ, φ, and ψ. In the example embodiment, the variance—damage parameter V_{σ}_{_{eq}} is calculated with angles θ, φ, and ψ incremented every 5°. In other embodiments, the angles θ, φ, and ψ may be incremented between 1° and 10° for each calculation. The maximum variance is calculated using equation (4) below.

In the example embodiment, using transformation matrix [A] and the variance matrix [V], a variance—damage parameter V_{σ}_{_{eq}} is calculated using the following equation (4).

$${V}_{{σ}_{eq}} ( θ , φ , ψ ) = {[ A ] [ V ] [ A ]}^{T} , \qquad ( 4 )$$

where θ is the angle the plane makes with the X-axis (e.g., see FIG. 2), φ is the angle the plane makes with the Z-axis, ψ is the angle of equivalent shear in the shear plane, ω is the excitation frequency (e.g., from the load PSD), and T is denotes transpose matrix, as also shown in FIG. 6.

Accordingly, the maximum variance is calculated, and the angles θ, φ, and ψ at which the maximum damage is caused are obtained. The corresponding planes that are based on the angles θ, φ, and ψ of maximum damage are then labeled as the critical plane where a fatigue crack will potentially occur.

At step 150, a PSD damage parameter is calculated. In one example, the PSD damage parameter assesses the level of damage to the structure under dynamic loads by comparting the spectral density of a damaged structure's response to that of a reference structure. In the example embodiment, with the angles θ, φ, and ψ for the critical plane obtained in step 140, the PSD—damage parameter S_{σ}_{_{eq}} is calculated using the stress PSD matrix [S_{σ}(ω)] (step 120) and the damage transformation matrix [A] (120) in equation (5) shown below. The result is a stress PSD as a function of frequency.

$${{S}_{{σ}_{eq}} ( σ , φ , ψ , ω ) = [ A ] [ {S}_{σ} ( ω ) ] [ A ] )}^{T} , \qquad ( 5 )$$

where θ is the angle the plane makes with the X-axis (e.g., see FIG. 2), φ is the angle the plane makes with the Z-axis, ψ is the angle of equivalent shear in the shear plane, ω is the excitation frequency (e.g., from the load PSD), and T is denotes transpose matrix.

At step 160, the computing device calculates damage to estimate the fatigue life of the structure. In one example, a standard damage calculation is performed using the Dirlik fatigue procedure. Equations related to this procedure are found in FIGS. 7 and 8. This method step is based on the spectral moments calculated from the PSD response determined in step 150. All of the equations shown in FIGS. 7 and 8 depend on four moments that include M0, M1, M2, and M4. Once a stress probability density function (PDF) and a stress histogram are calculated, fatigue life is calculated using a stress number (S-N) curve and Miner's rule.

Accordingly, described herein are systems and methods for a critical plane based multi-axial fatigue analysis in frequency domain. The method includes a critical plane search technique with consideration of the shear stress components along the plane to identify a fatigue crack initiation plane or orientation. The fatigue damage parameters consider the fatigue damage mechanism for materials varying from brittle to ductile. This unique method is related to the frequency-based stress spectral density matrix and advantageously converts the transformation matrix [A] from a global coordinate system to any inclined critical plane. Additionally, the direct and shear transformation vectors (C_{σ} and C_{τ}) are unique to this method. As such, the complete frequency-based stress and fatigue calculation via finite element analysis and the random loading spectral density are formulated with this method.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A computer-implemented method for predicting fatigue life of a structure, comprising:
providing a finite element (FE) model of the structure;
calculating, with a computing device having one or more processors, a modal stress and a frequency response function (FRF) of the FE model;
calculating, with the computing device, a stress power spectral density (PSD) matrix;
calculating, with the computing device, a damage transformation matrix [A];
calculating, with the computing device, a covariance matrix from the stress PSD matrix;
determining, with the computing device, angles θ, φ, and ψ in a plane with maximum equivalent variance based on the calculated covariance matrix, where θ is an angle the plane makes with the x-axis, φ is an angle the plane makes with the z-axis, and ψ is an angle of equivalent shear in a shear plane; and
calculating, with the computing device, a variance—damage parameter with the angles θ, φ, and ψ incremented in a predetermined amount of degrees to thereby identify critical planes where a fatigue crack will occur in the structure.

2. The method of claim 1, further comprising:
calculating, with the computing device, a PSD—damage parameter based on the identified critical planes, the transformation matrix [A], and the PSD matrix to thereby provide a stress PSD as a function of frequency.

3. The method of claim 2, further comprising:
calculating, with the computing device, a damage based on the PSD—damage parameter, to thereby estimate the fatigue life of the structure.

4. The method of claim 1, wherein the damage transformation matrix [A] is calculated based on material constants of the structure and direct and shear transformation vectors.

5. The method of claim 1, wherein the predetermined increment of angles θ, φ, and ψ is 5°.

6. A computer-implemented method for predicting fatigue life of a structure, comprising:
providing a finite element (FE) model of the structure;
calculating, with a computing device having one or more processors, a modal stress and a frequency response function (FRF) of the FE model;
determining a unit dynamic stress response based on the calculated modal stress and FRF;
calculating, with the computing device, a stress power spectral density (PSD) matrix based on the determined unit dynamic stress response;
calculating, with the computing device, a damage transformation matrix [A] based on material constants of the structure and direct and shear transformation vectors;
calculating, with the computing device, a covariance matrix [V] from the stress PSD matrix using zeroth moment;
determining, with the computing device, angles θ, φ, and ψ in a plane with maximum equivalent variance based on the calculated covariance matrix [V], where θ is an angle the plane makes with the x-axis, φ is an angle the plane makes with the z-axis, and ψ is an angle of equivalent shear in a shear plane;
calculating, with the computing device, a variance—damage parameter with the angles θ, φ, and ψ incremented in a predetermined amount of degrees to thereby identify critical planes where a fatigue crack will occur in the structure;
calculating, with the computing device, a PSD—damage parameter based on the identified critical planes, the transformation matrix [A], and the PSD matrix to thereby provide a stress PSD as a function of frequency; and
calculating, with the computing device, a damage based on the PSD—damage parameter, to thereby estimate the fatigue life of the structure.

7. The method of claim 6, wherein the predetermined increment of angles θ, φ, and ψ is 5°.
